(19) United States
(12) Patent Application Publication
(10) Pub. No.: US 2024/0385459 A1
(43) Pub. Date: Nov. 21, 2024

(54) DISPLAY DEVICE

(71) Applicant: SAMSUNG DISPLAY CO., LTD., YONGIN-SI (KR)

(72) Inventors: HYUNGGUEN YOON, Yongin-si (KR); SEUNGBEOM PARK, Yongin-si (KR); SUK HOON KANG, Yongin-si (KR); JEONGSOO KIM, Yongin-si (KR)

(21) Appl. No.: 18/624,306

(22) Filed: Apr. 2, 2024

(30) Foreign Application Priority Data
May 18, 2023 (KR) 10-2023-0064474

(51) Int. Cl. G02B 27/28; G02B 5/08; G02B 5/30

(52) U.S. Cl. CPC G02B 27/288; G02B 5/0808; G02B 5/3058; G02B 27/286

(57) ABSTRACT

A display device includes a display panel including a light-emitting layer, an optical layer disposed on the display panel, and an optical lens disposed on the optical layer and including an optical lens phase retardation layer in which circularly polarized light provided from the optical layer is converted into linearly polarized light. The optical layer includes a first phase retardation layer disposed on the display panel, a selective reflection layer disposed on the first phase retardation layer and configured to output linearly polarized light by transmitting light coincident with a polarization axis and to reflect light not coincident with the polarization axis, and a second phase retardation layer disposed on the selective reflection layer in which the linearly polarized light incident from the selective reflection layer is converted into the circularly polarized light.

### CROSS-REFERENCE TO RELATED APPLICATIONS

This application claims priority under 35 U.S.C. § 119 to Korean Patent Application No. 10-2023-0064474, filed on May 18, 2023, the entire contents of which are hereby incorporated by reference.

### TECHNICAL FIELD

The present disclosure herein relates to a display device for reliably producing an image.

### DISCUSSION OF RELATED ART

Augmented reality typically involves the display of a single image that includes a virtual image superimposed on a real image visible to user's eyes. An augmented reality image may be displayed by using a head mounted display (HMD), a head-up display (HUD), and the like. When the augmented reality image is displayed by using a head mounted display, the head mounted display may be provided in a form of an eyeglass (or eyeglasses), which may be easy for a user to carry, put on, or take off.

A head mounted display typically reduces a distance between viewer's eyes and a display, and may block a field of view. In some cases, performance requirements for displaying an augmented reality image may be difficult for the head mounted display to meet. To address these issues, the head mounted display may use a micro display, which may be smaller than typical displays. Micro displays typically include lenses with a short focal length. Also, micro displays typically have small pixels. The short focal length and small pixels of the micro displays may make it possible for an optical portion of a head mounted display to have an increased spatial resolution.

### SUMMARY

The present disclosure provides a display device capable of reducing light loss and the occurrence of ghost images.

An embodiment of the inventive concept provides a display device including: a display panel including a light-emitting layer; an optical layer disposed on the display panel; and an optical lens disposed on the optical layer and including an optical lens phase retardation layer in which circularly polarized light provided from the optical layer is converted into linearly polarized light, wherein the optical layer includes a first phase retardation layer disposed on the display panel, a selective reflection layer disposed on the first phase retardation layer and configured to output linearly polarized light by transmitting light coincident with a polarization axis and to reflect light not coincident with the polarization axis, and a second phase retardation layer disposed on the selective reflection layer in which the linearly polarized light incident from the selective reflection layer is converted into the circularly polarized light.

In an embodiment, the optical lens may include a reflective mirror disposed on the optical layer.

In an embodiment, the optical layer may include a polarization layer disposed between the selective reflection layer and the second phase retardation layer.

In an embodiment, the polarization layer may include a linear polarizer which linearly polarizes incident light, and absorbs light reflected by the reflective mirror.

In an embodiment, an intersection angle at which an optical axis of the first phase retardation layer and a polarization axis of the polarization layer cross each other may be about 45°.

In an embodiment, the reflective mirror may include a focus lens which controls a focal length.

In an embodiment, the optical lens may further include a wire grid polarization layer disposed on the optical lens phase retardation layer.

In an embodiment, the selective reflection layer may include a first protective coating layer, a reflective film layer, and a second protective coating layer, sequentially stacked, and the reflective film layer comprises a plurality of layers having respectively different refractive indices that are alternately stacked.

In an embodiment, the selective reflection layer may have a thickness of about 350 μm to about 450 μm.

In an embodiment, a portion of light incident on the optical lens from the optical layer may be reflected by the optical lens, and the optical lens may change a phase of the light reflected to have an opposite phase from the light incident on the optical lens from the optical layer.

In an embodiment, each of the first phase retardation layer and the second phase retardation layer may include a λ/4 phase retarder.

In an embodiment, the display panel may further include a color filter layer disposed on the light-emitting layer.

In an embodiment of the inventive concept, a display device includes: a display panel including a light-emitting layer; an optical layer disposed on the display panel; and an optical lens disposed on the optical layer and including a reflective mirror which reflects a portion of light provided from the optical layer, wherein the optical layer includes a first phase retardation layer disposed on the display panel, a selective reflection layer disposed on the first phase retardation layer and configured to output linearly polarized light by transmitting light coincident with a polarization axis and to reflect light not coincident with the polarization axis, and a polarization layer disposed on the selective reflection layer and configured to absorb light reflected by the reflective mirror.

In an embodiment, the optical layer may further include a second phase retardation layer in which the linearly polarized light incident from the selective reflection layer may be converted into circularly polarized light, wherein the second phase retardation layer may be disposed on the selective reflection layer and may be configured to convert the linearly polarized light incident from the selective reflection layer into circularly polarized light.

In an embodiment, the optical lens further may include a phase retardation layer in which the circularly polarized light provided from the reflective mirror may be converted into linearly polarized light, wherein the phase retardation layer is disposed on the reflective mirror.

In an embodiment, the phase retardation layer may have a λ/4 phase retarder, and the optical lens further comprises a wire grid polarization layer disposed on the phase retardation layer.

In an embodiment, the polarization layer may include a linear polarizer which linearly polarizes incident light, and absorbs light reflected by the reflective mirror, and the reflective mirror comprises a focus lens which controls a focal length.

In an embodiment of the inventive concept, a display device includes: a display panel including a light-emitting layer; an optical layer disposed on the display panel; and an optical lens disposed on the optical layer and including an optical lens phase retardation layer in which circularly polarized light provided from the optical layer is converted into linearly polarized light and output by the display device, wherein the optical layer includes: a selective reflection layer disposed on the display panel and configured to output linearly polarized light by transmitting light coincident with a polarization axis and to reflect light not coincident with the polarization axis; and a second phase retardation layer disposed on the selective reflection layer in which the linearly polarized light incident from the selective reflection layer is converted into the circularly polarized light.

In an embodiment, the optical layer may include a polarization layer disposed between the selective reflection layer and the second phase retardation layer, wherein the polarization layer may include a linear polarizer which linearly polarizes incident light, and absorbs light reflected by the reflective mirror.

In an embodiment, the selective reflection layer may include a reflective film layer in which a plurality of layers having respectively different refractive indices are alternately stacked.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view illustrating a display device according to an embodiment of the inventive concept;

FIG. 2 is a cross-sectional view illustrating a display device according to an embodiment of the inventive concept;

FIG. 3 is a cross-sectional view illustrating a display panel according to an embodiment of the inventive concept;

FIG. 4A is a cross-sectional view of an optical layer according to an embodiment of the inventive concept;

FIG. 4B is a cross-sectional view of a selective reflection layer according to an embodiment of the inventive concept;

FIG. 5 is a cross-sectional view illustrating a display device according to an embodiment of the inventive concept;

FIG. 6 is a cross-sectional view illustrating a display device according to an embodiment of the inventive concept;

FIG. 7 is a cross-sectional view illustrating a part of a display device according to an embodiment of the inventive concept; and

FIG. 8 is a cross-sectional view of a reflective mirror according to an embodiment of the inventive concept.

### DETAILED DESCRIPTION

The inventive concept may be implemented in various modifications and have various forms, and specific embodiments are illustrated in the drawings and described in detail in the text. It is to be understood, however, that the inventive concept is not intended to be limited to the particular forms disclosed, but on the contrary, is intended to cover all modifications, equivalents, and alternatives falling within the spirit and scope of the inventive concept.

In this specification, it will be understood that when an element (or region, layer, portion, or the like) is referred to as being “on”, “connected to” or “coupled to” another element, it may be directly disposed/connected/coupled to another element, or intervening elements may be disposed therebetween.

Like reference numerals or symbols refer to like elements throughout. In the drawings, the thickness, the ratio, and the dimension of the elements may be exaggerated for effective description of the technical contents.

The term “and/or” includes all combinations of one or more of the associated listed elements.

Although the terms first, second, etc., may be used to describe various elements, these elements should not be limited by these terms. These terms are only used to distinguish one element from another element. For example, a first element may be referred to as a second element, and similarly, a second element may also be referred to as a first element without departing from the scope of the inventive concept. The singular forms include the plural forms unless the context clearly indicates otherwise.

Also, the terms such as “below”, “lower”, “above”, “upper” or the like, may be used in the description to describe one element's relationship to another element illustrated in the figures. It will be understood that the terms have a relative concept and may be described on the basis of the orientation depicted in the figures.

Unless otherwise defined, all terms (including technical and scientific terms) used herein have the same meaning as commonly understood by one of ordinary skill in the art to which the present disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Hereinafter, embodiments of the inventive concept are described with reference to the accompanying drawings.

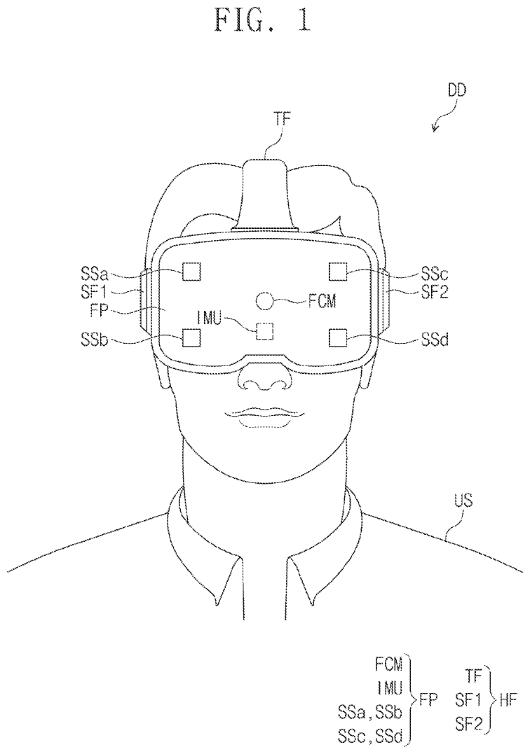

FIG. 1 is a plan view illustrating a display device according to an embodiment of the inventive concept. FIG. 1 illustrates a head mounted display as an example of the inventive concept.

Referring to FIG. 1, a display device DD according to an embodiment of the inventive concept may include a head mounted display (HMD). The display device DD illustrated in FIG. 1 has a form of goggles worn on a head. The display device DD may generate a virtual image, which may be displayed and perceived by a user US wearing the goggles.

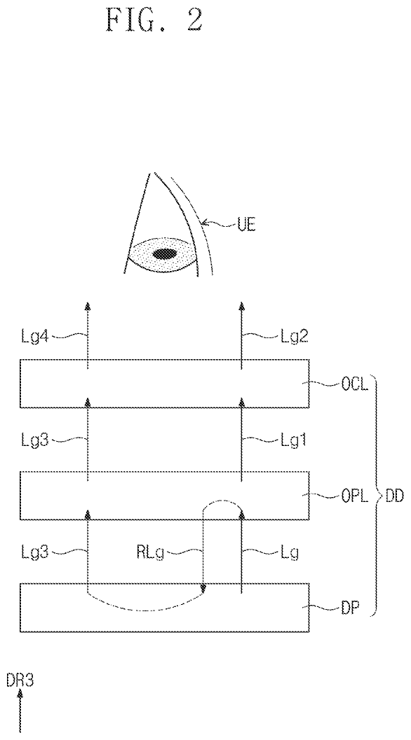

The display device DD may include a front module FP and a head frame HF. The front module FP may provide a virtual image and the head frame HF may fix the front module FP to a head of the user. The front module FP may include a front camera FCM and a plurality of sensors SSa, SSb, SSc, and SSd. The head frame HF may include a top frame TF and side frames SF1 and SF2. The top frame TF may extend on the top of the head of the user US. The side frames SF1 and SF2 may extend on the sides of the head of the user US. The top frame TF and the side frames SF1 and SF 2 may be coupled to each other. Although not illustrated, as discussed herein with reference to FIG. 2 and subsequent drawings, the display device DD may include an optical lens system. For example, the display device DD may further include one or more display panels and optical lenses, which may correspond to the front module FP and may be oriented toward the eyes (not illustrated) of the user US.

The plurality of sensors SSa, SSb, SSc, and SSd may each be a light sensor. The plurality of sensors SSa, SSb, SSc, and SSd may each detect optical information output from an external device, not illustrated in FIG. 1, and use the optical information to provide information for determining a position and an orientation of the display device DD. FIG. 1 illustrates the display device DD having the four sensors SSa, SSb, SSc, and SSd, but an embodiment of the inventive concept is not limited thereto. The front camera FCM may image an external environment and provide information about the external environment to the user US. The front camera FCM and the plurality of sensors SSa, SSb, SSc, and SSd may be disposed to face the external environment in a front direction. The front direction may be the same direction as a field of view of the user US.

According to an embodiment of the inventive concept, the top frame TF and the side frames SF1 and SF2 may be connected and coupled to each other. The top frame TF and the side frames SF1 and SF2 may each be coupled to the front module FP and may fix the front module FP to the head of the user US. In an embodiment of the inventive concept, the display device DD may have a band-like structure, but is not limited thereto. The display device DD may have an eyeglass-like or helmet-like structure. The head frame HF may include different or other supporting structures (for example, nose piece, chin strap, or the like) not illustrated in FIG. 1.

The display device DD may further include an inertial measurement unit (IMU). The IMU may measure data about one or more of a force applied to the display device DD, a position of the display device DD, or a magnetic field surrounding the display device DD. The IMU may provide information pertaining to the data measured.

FIG. 2 is a cross-sectional view illustrating a display device according to an embodiment of the inventive concept. FIG. 2 is a view illustrating a path of light generated by the display device DD. Specifically, FIG. 2 is a view illustrating a path of light provided to eyes UE of the user US (see FIG. 1) via the display device DD.

Referring to FIG. 2, the display device DD may include a display panel DP, an optical layer OPL, and an optical lens OCL. The display panel DP may generate light Lg. The optical layer OPL may be disposed on the display panel DP. The optical lens OCL may be disposed adjacent to the eyes UE of the user US.

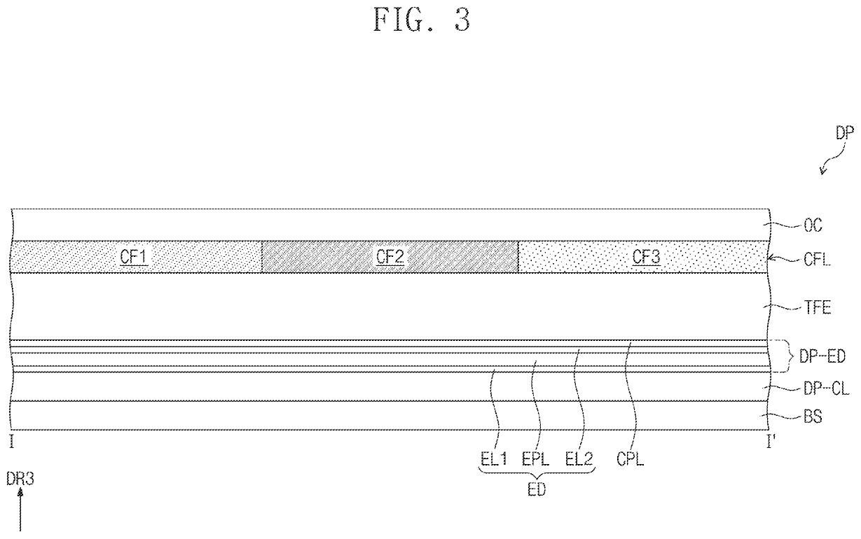

The display panel DP may emit the light Lg. Specifically, as illustrated in FIG. 3, the light Lg may be emitted from a light-emitting layer ED included in the display panel DP. The light Lg may be provided to the optical layer OPL disposed on the display panel DP. A first portion of the light Lg provided to the optical layer OPL may pass through the optical layer OPL, and a second portion of the light Lg may be reflected by the optical layer OPL. The second portion of the light Lg may be reflected by the optical layer OPL to the display panel DP. The first portion of the light, which has passed through the optical layer OPL, may be defined as first light Lg1, and the second portion of the light, which has been reflected by the optical layer OPL, may be defined as reflected light RLg. The first light Lg1 may be light circularly polarized by the optical layer OPL. The circularly polarized first light Lg1 may be converted into second light Lg2 while passing through the optical lens OCL disposed on the optical layer OPL. The second light Lg2 may be light linearly polarized by the optical lens OCL. The second light Lg2 output from the optical lens OCL may be provided to the eyes UE of the user US. A detailed description thereof is provided herein.

The reflected light RLg may be light circularly polarized by the optical layer OPL. The reflected light RLg may be one of left circularly polarized light or right circularly polarized light. Portion of the reflected light RLg may be reflected by the display panel DP (for example, by a signal wire included in the first electrode EL1 or the circuit layer DP-CL which is illustrated in FIG. 3). The light reflected by the display panel DP may be defined as third light Lg3. While being reflected by the display panel DP, the third light Lg3 may have a phase opposite to that of the reflected light RLg. For example, when the reflected light RLg is in a state of being right-circularly polarized, the third light Lg3 may be in a state of being left-circularly polarized, or when the reflected light RLg is in a state of being left-circularly polarized, the third light Lg3 may be in a state of being right-circularly polarized. The third light Lg3 may pass through the optical layer OPL and may be provided to the optical lens OCL. The circularly polarized third light Lg3 may be converted into fourth light Lg4 linearly polarized by the optical lens OCL, and the fourth light Lg4 may be displayed by the display device DD and may be provided to the eyes UE of the user US. A detailed description thereof is provided herein.

FIG. 3 is a cross-sectional view illustrating a display panel according to an embodiment of the inventive concept.

In a display device DD according to an embodiment of the inventive concept, a display panel DP may be a light-emitting display panel. For example, the display panel DP may be an organic electroluminescence display panel, or a quantum dot light-emitting display panel. However, embodiments of the inventive concept is not limited thereto.

Referring to FIG. 3, the display panel DP may include a base layer BS, a circuit layer DP-CL disposed on the base layer BS, a display layer DP-ED disposed on the circuit layer DP-CL, and an encapsulation layer TFE disposed on the display layer DP-ED. In addition, the display panel DP may further include a color filter layer CFL disposed on the encapsulation layer TFE and a planarization layer OC disposed on the color filter layer CFL.

The base layer BS may be a member that provides a base surface on which the circuit layer DP-CL is disposed. The base layer BS may be a rigid substrate or a flexible substrate capable of being bent, folded, rolled, or the like. According to an embodiment of the inventive concept, the base layer BS may be a glass substrate, a metal substrate, a polymer substrate, or like. Alternatively, according to an embodiment, the base layer BS may be a silicon wafer. However, embodiments of the inventive concept are not limited thereto, and the base layer BS may be an inorganic layer, an organic layer, or a composite material layer. According to an embodiment, the base layer BS may be a single-layered structure or a multi-layered structure.

The circuit layer DP-CL may be disposed on the base layer BS. The circuit layer DP-CL may include an insulating layer, a semiconductor pattern, a conductive pattern, a signal line, or the like. The insulating layer, the semiconductor layer, and the conductive layer may be formed on the base substrate BS through coating, deposition, etc. The insulating layer, the semiconductor layer, and the conductive layer may be selectively patterned by performing a photolithography process multiple times. Thereafter, the semiconductor pattern, the conductive pattern, and the signal line included in the circuit layer DP-CL may be formed.

In the case of an embodiment in which the base layer BS is a silicon wafer, the circuit layer DP-CL may be formed by performing a complementary metal-oxide semiconductor (CMOS) process on the silicon wafer. In this case, the circuit layer DP-CL may include a fine semiconductor pattern, a conductive pattern, or the like. The display panel DP formed of a silicon wafer and having the circuit layer DP-CL formed by performing a CMOS process may have a high-resolution.

The display layer DP-ED may be disposed on the circuit layer DP-CL. The display layer DP-ED may include a light-emitting element ED and a capping layer CPL.

The light-emitting element ED may include a first electrode EL1, a light-emitting layer EPL disposed on the first electrode EL1, and a second electrode EL2 disposed on the light-emitting layer EPL. Although not illustrated, the light-emitting element ED may further include a hole transport region disposed between the first electrode EL1 and the light-emitting layer EPL, and an electron transport region disposed between the light-emitting layer EPL and the second electrode EL2.

The first electrode EL1 may be directly disposed on the circuit layer DP-CL. According to an embodiment of the inventive concept, the first electrode EL1 may be an anode. The first electrode EL1 may have a stacked structure including a metal material. For example, the first electrode EL1 may have a stacked structure of a reflective layer and a translucent layer. The reflective layer may include magnesium (Mg), aluminum (Al), platinum (Pt), palladium (Pd), gold (Au), nickel (Ni), neodymium (Nd), iridium (Ir), chromium (Cr), compounds thereof, etc. The translucent layer may include at least one selected from the group including indium tin oxide (ITO), indium zinc oxide (IZO), indium gallium zinc oxide (IGZO), zinc oxide (ZnO), indium oxide (In2O3), or aluminum-doped zinc oxide (AZO).

The light-emitting layer EPL may be disposed on the first electrode EL1. According to an embodiment of the inventive concept, the light-emitting layer EPL may be provided on the first electrode EL1 as a common layer. The light-emitting layer EPL may overlap both a pixel region and a non-pixel region. That is, the light-emitting element ED may be a light-emitting element having a tandem structure. In the tandem structure, a plurality of layers may be stacked in series. The layers may emit light having different ranges of wavelengths. According to an embodiment, the light-emitting layer EPL may emit white light. The plurality of layers of the light-emitting layer EPL may be variously stacked. Different arrangements of the layers may be disposed in a pattern, and the light-emitting layer EPL including an individual pattern may be provided. In this case, patterns of the light-emitting layer EPL may respectively emit light having different colors from each other.

The second electrode EL2 may be disposed on the light-emitting layer EPL. The second electrode EL2 may be a cathode. According to an embodiment of the inventive concept, the second electrode EL2 may be provided in the light-emitting element ED as a common layer. That is, the second electrode EL2 may be provided on the light-emitting layer EPL as a common electrode. The second electrode EL2 may be transparent. The second electrode EL2 may overlap both the pixel region and the non-pixel region.

The capping layer CPL may be disposed on the second electrode EL2. The capping layer CPL may cover the light-emitting element ED. The capping layer CPL may protect the light-emitting element ED against moisture or foreign substances introduced from the outside. The capping layer CPL may include an organic material.

The encapsulation layer TFE may be disposed on the display layer DP-ED. The encapsulation layer TFE may include at least one inorganic film (hereinafter, inorganic encapsulation film). In addition, the encapsulation layer TFE may include at least one organic film (hereinafter, organic encapsulation film) and at least one inorganic encapsulation film.

The inorganic encapsulation film of the encapsulation layer TFE may protect the display layer DP-ED against moisture/oxygen, and the organic encapsulation film of the encapsulation layer TFE may protect the display layer DP-ED against foreign substances such as dust particles. The inorganic encapsulation film may include silicon nitride, silicon oxynitride, silicon oxide, titanium oxide, aluminum oxide, or the like, but is not particularly limited thereto. The organic encapsulation film may include an acrylic compound, an epoxy-based compound, or the like. The organic encapsulation film may include a photopolymerizable organic material, and is not particularly limited thereto.

The color filter layer CFL may be disposed on the encapsulation layer TFE. The color filter layer CFL may include a plurality of color filters. The color filter layer CFL may include a first color filter CF1, a second color filter CF2, and a third color filter CF3. Although not illustrated, the color filter layer CFL may further include a light blocking layer (not illustrated). The light blocking layer may be disposed between the first color filter CF1, the second color filter CF2, and the third color filter CF3. The light blocking layer may be a black matrix. The light blocking layer may be formed to include an organic light blocking material or an inorganic light blocking material including a black pigment or a black dye. The light blocking layer may reduce or prevent light leakage and define boundaries between the first color filter CF1, the second color filter CF2, and the third color filter CF3 adjacent to each other. Meanwhile, in this specification, the wording “region/portion corresponds region/portion” means “overlapping each other”, and is not limited to having the same area.

The first color filter CF1, the second color filter CF2, and the third color filter CF3 may each include a polymer photosensitive resin and a colorant. The colorant may include a pigment and a dye. A red colorant may include a red pigment and a red dye, a green colorant may include a green pigment and a green dye, and a blue colorant may include a blue pigment and a blue dye. For example, the first color filter CF1 may include a red pigment or a red dye, the second color filter CF2 may include a blue pigment or a blue dye, and the third color filter CF3 may include a green pigment or a green dye. Among light provided from the light-emitting layer EPL, light passing through the first color filter CF1 may be provided as red light to the outside of the display panel DP, light passing through the second color filter CF2 may be provided as blue light to the outside of the display panel DP, and light passing through the third color filter CF3 may be provided as green light to the outside of the display panel DP.

The planarization layer OC may be disposed on the color filter layer CFL. The planarization layer OC may cover the first color filter CF1, the second color filter CF2, and the third color filter CF3. The planarization layer OC may include an organic material. The organic material may be transparent and may include, for example, an acrylic resin. The planarization layer OC may form an upper surface of the display panel DP. The planarization layer OC may provide a flat upper surface. The planarization layer OC may be omitted.

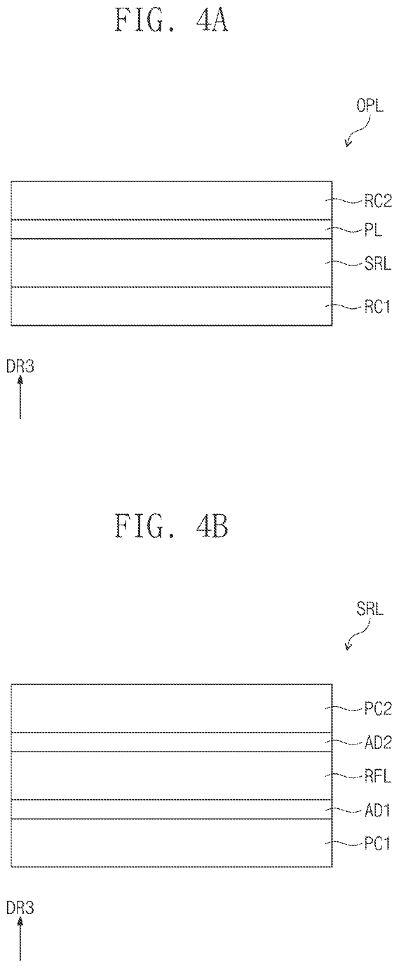

FIG. 4A is a cross-sectional view of an optical layer according to an embodiment of the inventive concept. FIG. 4B is a cross-sectional view of a selective reflection layer according to an embodiment of the inventive concept. Hereinafter, the optical layer OPL will be described with reference to FIG. 4A and FIG. 4B.

Referring to FIG. 4A, the optical layer OPL may include a first phase retardation layer RC1, a selective reflection layer SRL, a polarization layer PL, and a second phase retardation layer RC2. The first phase retardation layer RC1, the selective reflection layer SRL, the polarization layer PL, and the second phase retardation layer RC2 may be sequentially stacked in a third direction DR3, which is a thickness direction of the optical layer OPL. In detail, the selective reflection layer SRL may be disposed on the first phase retardation layer RC1, the polarization layer PL may be disposed on the selective reflection layer SRL, and the second phase retardation layer RC2 may be disposed on the polarization layer PL.

Although not illustrated, the first phase retardation layer RC1 may be a component constituting a lower portion of the optical layer OPL. The first phase retardation layer RC1 may be disposed adjacent to the display panel DP (see FIG. 2). That is, a distance between the first phase retardation layer and the display panel may be shorter than a distance between the second phase retardation layer and the display panel. The first phase retardation layer RC1 may be a layer that retards a phase of light provided thereto. Phase retardation describes a change in a polarized state of light passing through a phase retarder. According to an embodiment of the inventive concept, the first phase retardation layer RC1 may include a N/4 phase retarder. For example, when light emitted from the display panel DP and provided to the first phase retardation layer RC1 has a wavelength of about 550 nm, light passing through the first phase retardation layer RC1 may have a phase retardation value of about 137.5 nm. In addition, the first phase retardation layer RC1 may have an optical anisotropy, and convert a polarized state of light incident thereon. That is, light emitted from the display panel DP and provided to the first phase retardation layer RC1 may be converted from a linear polarization state into a circular polarization state. Additionally, light emitted from the display panel DP and provided to the first phase retardation layer RC1 in a circularly polarized state may be converted into a linearly polarized state.

Referring to FIG. 4A and FIG. 4B together, the selective reflection layer SRL may be disposed on the first phase retardation layer RC1. The selective reflection layer SRL may include a plurality of layers sequentially stacked. The selective reflection layer SRL may include a first protective coating layer PC1, a reflective film layer RFL, and a second protective coating layer PC2. In addition, the selective reflection layer SRL may further include a first adhesive layer AD1 disposed between the first protective coating layer PC1 and the reflective film layer RFL, and a second adhesive layer AD2 disposed between the reflective film layer RFL and the second protective coating layer PC2. The first adhesive layer AD1 may bond the first protective coating layer PC1 and the reflective film layer RFL together, and the second adhesive layer AD2 may bond the reflective film layer RFL and the second protective coating layer PC2 together. The first adhesive layer AD1 and the second adhesive layer AD2 may each have a thickness of about 0.1 micrometers (μm) to about 2 μm. Alternatively, the first adhesive layer AD1 and the second adhesive layer AD2 may be omitted in the selective reflection layer SRL.

The first protective coating layer PC1 and the second protective coating layer PC2 may protect the reflective film layer RFL. For example, the first protective coating layer PC1 and the second protective coating layer PC2 may reduce or prevent moisture or foreign substances from being introduced into the reflective film layer RFL from the outside. The first protective coating layer PC1 and the second protective coating layer PC2 may have a same thickness. For example, the first protective coating layer PC1 and the second protective coating layer PC2 may each have a thickness of about 120 μm to about 150 μm. However, embodiments of the inventive concept is not limited thereto. The first protective coating layer PC1 and the second protective coating layer PC2 may have different thicknesses from each other.

According to an embodiment of the inventive concept, the reflective film layer RFL may include a plurality of layers having different refractive indices and the layers having different refractive indices may be alternately stacked. Specifically, the reflective film layer RFL may have a structure in which a high-refractive-index layer and a low-refractive-index layer having a refractive index different from that of the high-refractive-index layer are alternately stacked. The reflective film layer RFL may be formed from a multi-layered polymer layer through an ultra-thin film stacking molding technology. The thickness of the reflective film layer RFL may be less than the thickness of each of the first protective coating layer PC1 and the second protective coating layer PC2. The reflective film layer RFL may have a thickness of about 100 μm to about 120 μm.

According to an embodiment of the inventive concept, the selective reflection layer SRL may include a dual brightness enhancement film (DBEF). However, embodiments of the inventive concept is not limited thereto, and the selective reflection layer SRL may include a wire grid polarizer (WGP). Among light incident onto the selective reflection layer SRL, the selective reflection layer SRL may transmit light coincident with a polarization axis and may reflect light not coincident with the polarization axis. For example, the selective reflection layer SRL may be manufactured such that among light incident onto the selective reflection layer SRL, light may be transmitted in an X-axis having a same refractive index, and light may be reflected in a Y-axis having a different refractive index. Light transmitted through the selective reflection layer SRL, and light reflected from the selective reflection layer SRL, may be linearly polarized light. A linearly polarized direction of light transmitted through the selective reflection layer SRL, and a linearly polarized direction of light reflected from the selective reflection layer SRL may be perpendicular to each other.

Referring to FIG. 4A, the polarization layer PL may be disposed on the selective reflection layer SRL. According to an embodiment of the inventive concept, the polarization layer PL may include a linear polarizer as a layer that linearly polarizes, in one direction, the light provided to the polarization layer PL. The polarization layer PL may be a film-type linear polarizer including a stretched polymer film. For example, the stretched polymer film may be a stretched polyvinylalcohol-based film.

The polarization layer PL may be formed by adsorbing a dichromatic dye onto a stretched polymer film. For example, the polarization layer PL may be formed by adsorbing iodine onto a stretched polyvinyl alcohol film. In this case, a direction in which a polymer film is stretched may be an absorption axis of the polarization layer PL, and a direction perpendicular to the stretched direction may be a transmission axis of the polarization layer PL. The polarization layer PL may be formed on the selective reflection layer SRL through coating. That is, the polarization layer PL may be a liquid crystal coating layer.

Although not illustrated in the drawing, the polarization layer PL may further include at least one protective layer. For example, the polarization layer PL may further include a triacetyl cellulose (TAC) layer disposed on at least one of an upper surface or a lower surface thereof. In addition, an embodiment of the inventive concept is not limited thereto, and the polarization layer PL may further include, as a protective layer, a hard coating layer, an anti-reflection layer, an anti-glare layer, or the like.

The second phase retardation layer RC2 may be disposed on the polarization layer PL. The second phase retardation layer RC2 may be a layer which retards a phase of light provided thereto. According to an embodiment of the inventive concept, the second phase retardation layer RC2 may include a λ/4 phase retarder. However, embodiments of the inventive concept is not limited thereto, and the second phase retardation layer RC2 may be a layer that retards a provided light phase by λ/2. For example, when light passing through the polarization layer PL and provided to the second phase retardation layer RC2 has a wavelength of about 550 nm, light passing through the second phase retardation layer RC2 may have a phase retardation value of about 275 nm.

Additionally, the second phase retardation layer RC2 may have an optical anisotropy, and may convert a polarized state of light incident thereon. That is, light emitted from the polarization layer PL and provided to the second phase retardation layer RC2 may be converted from a linearly polarized state into a circularly polarized state. Also, light emitted from the polarization layer PL and provided to the second phase retardation layer RC2 may be converted from a circularly polarized state into a linearly polarized state.

The phase retardation value of the first phase retardation layer RC1 in the thickness direction may differ from the phase retardation value of the second phase retardation layer RC2 in the thickness direction. As an example, according to the inventive concept, one among the phase retardation value of the first phase retardation layer RC1 in the thickness direction and the phase retardation value of the second phase retardation layer RC2 in the thickness direction may have a positive value, and the other may have a negative value. For example, the first phase retardation layer RC1 may be a positive A-plate, and the second phase retardation layer RC2 may be a negative A-plate.

According to an embodiment of the inventive concept, the first phase retardation layer RC1 and the second phase retardation layer RC2 may each be a liquid crystal coating layer. The first phase retardation layer RC1 and the second phase retardation layer RC2 may each be a liquid crystal coating layer formed using a reactive liquid crystal monomer. The first phase retardation layer RC1 and the second phase retardation layer RC2 may each be composed of a liquid crystal coating layer, and may not include a base substrate serving as a support. The first phase retardation layer RC1 and the second phase retardation layer RC2 may each be composed of a liquid crystal coating layer, and an entire thickness of the display device DD (see FIG. 2) may be reduced.

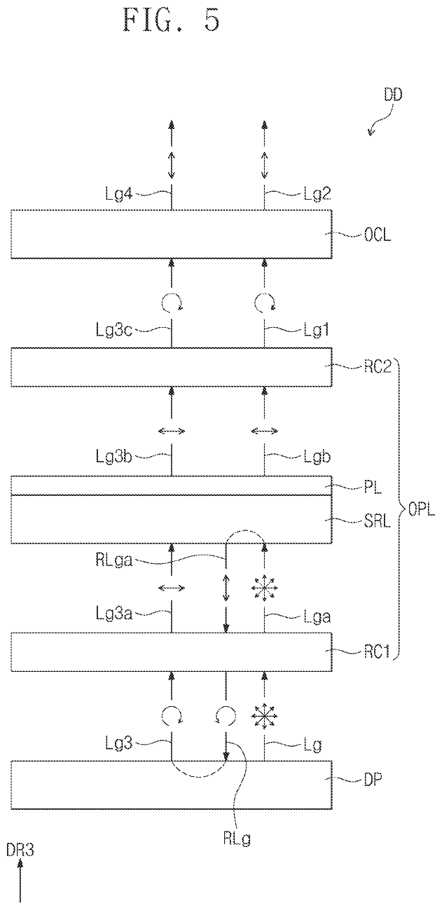

FIG. 5 is a cross-sectional view illustrating a display device according to an embodiment of the inventive concept. In the drawings, including FIG. 5, the phase(s) of different light may be graphically indicated as non-polarized light, linearly polarized light, or circularly polarized light. Further, a direction of the polarized-light may be indicated. The illustrated polarizations and directions are exemplary and not limiting. Moreover, it should be understood that while layers of the display device DD may be depicted in the drawings as being apart from one another, the layers may be disposed in contact with each other in a stack. For example, drawings may be used to illustrate certain conversions of light in certain layers.

Referring to FIG. 5, light Lg may be emitted from a display panel DP. The light Lg may include image information for forming an image. The light Lg emitted from a display panel DP may be in a state in which various phases coexist. The light Lg may be provided to a first phase retardation layer RC1. Light Lga passing through the first phase retardation layer RC1 may be provided to a selective reflection layer SRL. Among the light Lga provided to the selective reflection layer SRL, light Lgb having a component coincident with that of the polarization axis of the selective reflection layer SRL may pass through the selective reflection layer SRL, and the other may be reflected from the selective reflection layer SRL and may be provided to the first phase retardation layer RC1 as reflected light RLga. The light Lgb, passing through the selective reflection layer SRL, and the reflected light RLga, reflected from the selective reflection layer SRL, may each be linearly polarized light. A linearly polarized direction of the light Lgb passing through the selective reflection layer SRL may be perpendicular to a linearly polarized direction of the reflected light RLga reflected from the selective reflection layer SRL.

The light Lgb passing through the selective reflection layer SRL may be provided to a polarization layer PL. The polarization layer PL may allow light coincident with a polarization axis thereof to pass therethrough and absorb light not coincident with the polarization axis. The light Lgb passing through the selective reflection layer SRL may be coincident with the polarization axis of the polarization layer PL, thereby passing through the polarization layer PL without light loss from the polarization layer PL. The light Lgb passing through the polarization layer PL may be provided to a second phase retardation layer RC2. First light Lg1 passing through the second phase retardation layer RC2 may be right-circularly polarized light. That is, the second phase retardation layer RC2 may allow the linearly polarized light Lgb to be right-circularly polarized, and the right-circularly polarized first light Lg1 may be emitted from the second phase retardation layer RC2. The first light Lg1 emitted from the second phase retardation layer RC2 may be provided to an optical lens OCL. The circularly polarized first light Lg1 may be converted into linearly polarized second light Lg2 after passing through the optical lens OCL. That is, the optical lens OCL may emit the linearly polarized second light Lg2.

The reflected light RLga reflected from the selective reflection layer SRL may pass through the first phase retardation layer RC1. The reflected light RLga passing through the first phase retardation layer RC1 in a direction opposite to the third direction DR3 may be left-circularly polarized light. The reflected light RLga passing through the first phase retardation layer RC1 may be provided to the display panel DP. A portion of the reflected light RLga provided to the display panel DP may be reflected from the display panel DP. Specifically, the reflected light RLga provided to the display panel DP may be reflected from the first electrode EL1 or from a signal wire included in the circuit layer DP-CL, which is illustrated in FIG. 3, of the display panel DP. The left-circularly polarized reflected light RLga may be converted to light right-circularly polarized while being reflected from the second electrode EL2. That is, right-circularly polarized third light Lg3 may be provided to the first phase retardation layer RC1. The right-circularly polarized third light Lg3 may be considered to be re-provided to the first phase retardation layer RC1, following the light Lg emitted from a display panel DP. The first phase retardation layer RC1 may allow the right-circularly polarized third light Lg3 to be converted into linearly polarized third light Lg3a and to be emitted therefrom.

The third light Lg3a passing through the selective reflection layer SRL may be provided to the polarization layer PL. The third light Lg3a passing through the selective reflection layer SRL may be coincident with the polarization axis of the polarization layer PL, and may thereby pass through the polarization layer PL without light loss from the polarization layer PL. The third light Lg3b passing through the polarization layer PL may be provided to the second phase retardation layer RC2. Third light Lg3c passing through the second phase retardation layer RC2 may be right-circularly polarized light. That is, the second phase retardation layer RC2 may emit the right-circularly polarized third light Lg3c. The third light Lg3c emitted from the second phase retardation layer RC2 may be provided to the optical lens OCL. The third light Lg3c may be converted from circularly polarized light into linearly polarized light while passing through the optical lens OCL. That is, the optical lens OCL may emit linearly polarized fourth light Lg4.

Since the display device DD according to an embodiment of the inventive concept includes the selective reflection layer SRL, the reflected light RLga reflected from the selective reflection layer SRL may be reflected from the display panel DP and passed through the optical layer OPL and the optical lens OCL to be emitted as the fourth light Lg4. Therefore, it may be possible to minimize the loss of light Lg emitted from the display panel DP while passing through the optical layer OPL and the optical lens OCL. That is, a light emission efficiency of the display device DD may be increased.

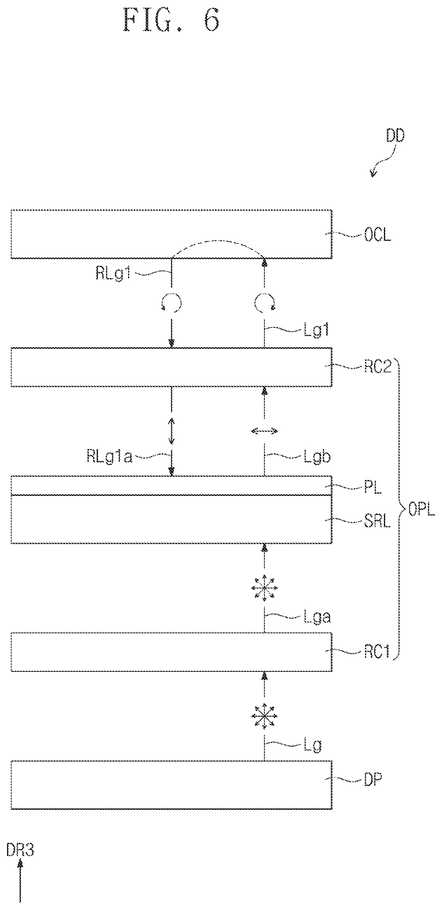

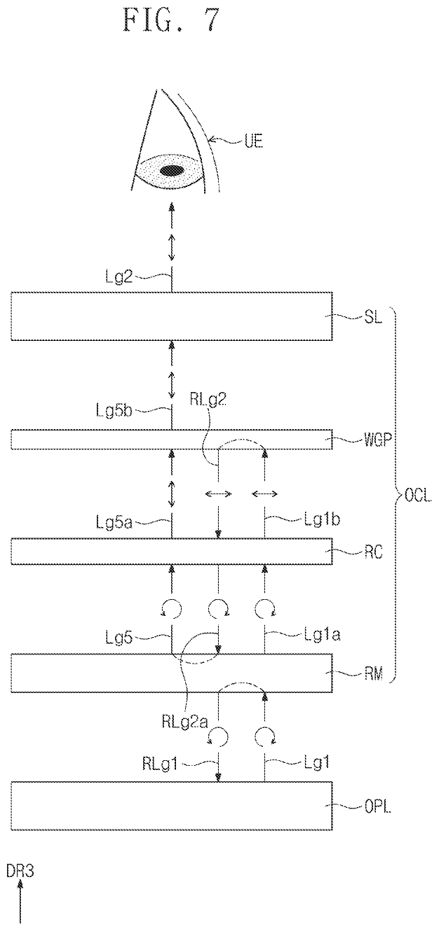

FIG. 6 is a cross-sectional view illustrating a display device according to an embodiment of the inventive concept. FIG. 7 is a cross-sectional view illustrating of a display device according to an embodiment of the inventive concept. Specifically, FIG. 7 is a cross-sectional view illustrating an optical layer OPL and an optical lens OCL. Hereinafter, duplicate descriptions of elements, features, or steps described elsewhere herein may be omitted.

Referring to FIG. 6, light Lg may be emitted from a display panel DP. The light Lg emitted from the display panel DP may pass through an optical layer OPL. First light Lg1, which passes through the optical layer OPL and is right-circularly polarized, may be provided to an optical lens OCL. A portion of the first light Lg1 provided to the optical lens OCL may be reflected by the optical lens OCL. The optical lens OCL may change a phase of the first reflected light RLg1 to have an opposite phase from the first light Lg1 incident on the optical lens from the optical layer. Referring to FIG. 7, a portion of the first light Lg1 may be reflected from a reflective mirror RM included in the optical lens OCL. First reflected light RLg1 reflected from the optical lens OCL may be left-circularly polarized light. That is, the first light Lg1 and the first reflected light RLg1 may have phases opposite to each other.

The first reflected light RLg1 may be provided to a second phase retardation layer RC2 in a direction opposite to the third direction DR3. The first reflected light RLg1 may be light that is linearly polarized while passing through the second phase retardation layer RC2. Linearly polarized first reflected light RLg1a may be provided to a polarization layer PL. The linearly polarized first reflected light RLg1a may be perpendicular to a polarization axis of the polarization layer PL. The polarization layer PL may allow light coincident with the polarization axis thereof to pass therethrough and absorb light not coincident with the polarization axis. That is, since the first reflected light RLg1a is not coincident with the polarization axis of the polarization layer PL, the first reflected light RLg1a may be absorbed by the polarization layer PL. In an example, the first reflected light RLg1a may be completely absorbed by the polarization layer PL.

In an embodiment in which the polarization layer PL is not disposed, the first reflected light RLg1a may be reflected from the selective reflection layer SRL, and light having a phase opposite to that of the first light Lg1 may be provided to the optical lens OCL. Since the light having a phase opposite to that of the first light Lg1 is provided to the optical lens OCL, a ghost image may be generated and projected toward the eyes UE (see FIG. 2) of the user US (see FIG. 1). Specifically, a ghost image phenomenon in which images appear to be superimposed may occur since in addition to the first light Lg1, light having the phase opposite to that of the first light Lg1 may be provided to the optical lens OCL and reach, at a time interval, the eyes UE of the user US. The display device DD according to an embodiment of the inventive concept may include the polarization layer PL disposed on the selective reflection layer SRL, and the polarization layer PL may absorb the first reflected light RLg1a. An absorption of the first reflected light RLg1a may reduce or prevent the occurrence of a ghost image phenomenon. That is, the display device DD may reliably produce an image, whereby the occurrence of the ghost image phenomenon may be reduced or prevented.

Referring to FIG. 7, an optical lens OCL may include a reflective mirror RM, an optical lens phase retardation layer RC, and a wire grid polarization layer WGP. The reflective mirror RM may be disposed adjacent to an optical layer OPL. The optical lens phase retardation layer RC may be disposed on the reflective mirror RM. The wire grid polarization layer WGP may be disposed on the optical lens phase retardation layer RC. Although not illustrated, the optical lens OCL may further include additional optical structures, such as refractive or diffractive lenses, partial reflective coatings, wavelength plates, reflective polarizers, linear polarizers, anti-reflective coatings, additional spatially variable polarizers or other optical structures, which may enable light to be focused on the eyes UE of the user US (see FIG. 1). The optical lens OCL may further include an auxiliary lens SL disposed on the wire grid polarization layer WGP.

First light Lg1 emitted from the optical layer OPL may be provided to the reflective mirror RM. A first portion of the first light Lg1 provided to the reflective mirror RM may pass through the reflective mirror RM, and a second portion of the first light Lg1 provided to the reflective mirror RM may be reflected from the reflective mirror RM. The amount of first light Lg1a passing through the reflective mirror RM may be the same as the amount of first reflected light RLg1 reflected from the reflective mirror RM. That is, about 50% of the first light Lg1 may pass through the reflective mirror RM.

The first light Lg1a passing through the reflective mirror RM may be provided to the optical lens phase retardation layer RC. The optical lens phase retardation layer RC may delay a phase of light provided to the optical lens phase retardation layer RC. According to an embodiment of the inventive concept, the optical lens phase retardation layer RC may be a N4 phase retarder. In addition, the optical lens phase retardation layer RC may have an optical anisotropy and may convert a polarized state of light incident thereon. That is, light, emitted from the reflective mirror RM and provided to the optical lens phase retardation layer RC, may be converted from a circularly polarized state into a linearly polarized state. Alternatively, light emitted from the reflective mirror RM and provide to the optical lens phase retardation layer RC may be converted from a linearly polarized state into a circularly polarized state.

The first light Lg1a may be converted from a right-circularly polarized state into a linearly polarized state while passing through the optical lens phase retardation layer RC. First light Lg1b emitted from the optical lens phase retardation layer RC may be provided to the wire grid polarization layer WGP. The wire grid polarization layer WGP may have reflection and transmission (or passing through) axes orthogonal thereto. Light polarized to be parallel to the reflection axis of the wire grid polarization layer WGP may be reflected from the wire grid polarization layer WGP, and light polarized to be parallel to the transmission axis may pass through the wire grid polarization layer WGP. According to the inventive concept, the first light Lg1b may be linearly polarized light so as to be parallel to the reflection axis of the wire grid polarization layer WGP. That is, the first light Lg1a provided to the wire grid polarization layer WGP may be reflected and provided to the optical lens phase retardation layer RC as second reflected light RLg2. In an example, the first light Lg1a provided to the wire grid polarization layer WGP may be completely reflected and provided to the optical lens phase retardation layer RC as second reflected light RLg2.

Second reflected light RLg2a passing through the optical lens phase retardation layer RC may be converted from a linearly polarized state into a right-circularly polarized state. The right-circularly polarized second reflected light RLg2a may be provided to the reflective mirror RM. A portion of the right-circularly polarized second reflected light RLg2a may be reflected from the reflective mirror RM. While being reflected from the reflective mirror RM, fifth light Lg5 may be converted from a right-circularly polarized state into a left-circularly polarized state. That is, while the fifth light Lg5 is reflected from the reflective mirror RM, a phase of the fifth light Lg5 may be reversed. The fifth light Lg5 reflected from the reflective mirror RM may have about 50% of the light of the second reflected light RLg2a.

The fifth light Lg5 may be provided to the optical lens phase retardation layer RC. The fifth light Lg5 may be light converted from left-circularly polarized light into linearly polarized light while passing through the optical lens phase retardation layer RC. Linearly polarized fifth light Lg5a may be provided to the wire grid polarization layer WGP. A linearly polarized direction of the fifth light Lg5a may be perpendicular to a linearly polarized direction of the first light Lg1b. According to the inventive concept, the fifth light Lg5a may be linearly polarized light to be parallel to a transmission axis of the wire grid polarization layer WGP. That is, the fifth light Lg5a provided to the wire grid polarization layer WGP may pass through the wire grid polarization layer WGP. In an example, the fifth light Lg5a provided to the wire grid polarization layer WGP may completely pass through the wire grid polarization layer WGP.

Fifth light Lg5b passing through the wire grid polarization layer WGP may be provided to the auxiliary lens SL disposed on the wire grid polarization layer WGP. The auxiliary lens SL may include a convex lens such that light provided to the auxiliary lens SL may be focused on a point coincident with the eyes UE of the user US. Second light Lg2 passing through the auxiliary lens SL may be output by the display device DD and provided to the eyes UE of the user US. That is, due to the second light Lg2, an image corresponding to the second light Lg2 may be output by the display device DD and provided to the eyes UE of the user US.

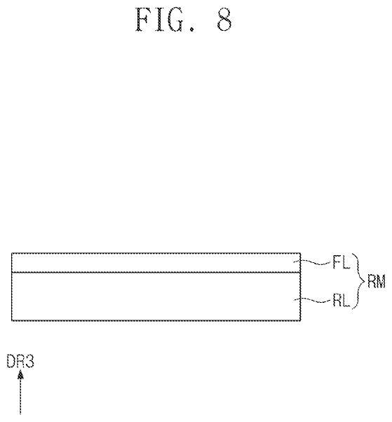

FIG. 8 is a cross-sectional view of a reflective mirror according to an embodiment of the inventive concept.

Referring to FIG. 8, a reflective mirror RM may include a reflective lens RL and a focus lens FL disposed on the reflective lens RL.

The reflective lens RL may allow portion of the first light Lg1, illustrated in FIG. 7, provided to the reflective mirror RM to pass therethrough or allow a portion of the first light Lg1 to be reflected. The reflective lens RL may include a mirror. For example, the reflective lens RL may include a macro lens, a soft lens, a fisheye lens, a tilt-shift (TS) lens, or the like, according to distortion adjustment, resolution power, and/or a minimum focal length of a photograph. The reflective lens RL may be formed of a single component or multiple components.

The reflective mirror RM may further include a focus lens FL disposed on the reflective lens RL. The focus lens FL may control a focal length of the display device DD. The focus lens FL may be a lens which allows a focal length to be continuously changed, and thus a focal length may be changed according to the movement of the focus lens FL. Therefore, the first light Lg1 provided to the reflective mirror RM may be refracted or diffracted (partially focused) by the focus lens FL.

Since a display device according to an embodiment of the inventive concept may include a selective reflection layer, light emitted from a display panel may be partially reflected from the selective reflection layer in a direction opposite to the third direction DR3, and the reflected light may be reflected from the display panel, so that the reflected light may be provided to a user. Therefore, it is possible to minimize light loss caused while light emitted from the display panel passes through an optical layer and an optical lens included in the display device.

Additionally, since a display device according to an embodiment of the inventive concept includes a polarization layer disposed on a selective reflection layer, it may be possible to reduce or prevent the occurrence of a ghost image phenomenon by causing the polarization layer to absorb reflected light reflected from an optical lens. That is, a display device with improved reliability in image generation may be provided.

Although embodiments of the inventive concept have been described, it is understood that the inventive concept is not limited and various changes and modifications can be made by one ordinary skilled in the art within the spirit and scope of the inventive concept as hereinafter claimed.

Therefore, the technical scope of the inventive concept is not limited to the contents described in the detailed description of the specification, but should be determined by the claims.

What is claimed is:

1. A display device comprising:
a display panel including a light-emitting layer;
an optical layer disposed on the display panel; and
an optical lens disposed on the optical layer and including an optical lens phase retardation layer in which circularly polarized light provided from the optical layer is converted into linearly polarized light,
wherein the optical layer comprises:
a first phase retardation layer disposed on the display panel;
a selective reflection layer disposed on the first phase retardation layer and configured to output linearly polarized light by transmitting light coincident with a polarization axis and to reflect light not coincident with the polarization axis; and
a second phase retardation layer disposed on the selective reflection layer in which the linearly polarized light incident from the selective reflection layer is converted into the circularly polarized light.

2. The display device of claim 1, wherein the optical lens comprises a reflective mirror disposed on the optical layer.

3. The display device of claim 2, wherein the optical layer comprises a polarization layer disposed between the selective reflection layer and the second phase retardation layer.

4. The display device of claim 3, wherein the polarization layer comprises a linear polarizer which linearly polarizes incident light, and absorbs light reflected by the reflective mirror.

5. The display device of claim 3, wherein an intersection angle at which an optical axis of the first phase retardation layer and a polarization axis of the polarization layer cross each other is about 45°.

6. The display device of claim 2, wherein the reflective mirror comprises a focus lens which controls a focal length.

7. The display device of claim 1, wherein the optical lens comprises a wire grid polarization layer disposed on the optical lens phase retardation layer.

8. The display device of claim 1, wherein the selective reflection layer comprises a first protective coating layer, a reflective film layer, and a second protective coating layer, sequentially stacked, and the reflective film layer comprises a plurality of layers having respectively different refractive indices that are alternately stacked.

9. The display device of claim 1, wherein the selective reflection layer has a thickness of about 350 micrometers to about 450 micrometers.

10. The display device of claim 1, wherein a portion of light incident on the optical lens from the optical layer is reflected by the optical lens, and the optical lens changes a phase of the light reflected to have an opposite phase from the light incident on the optical lens from the optical layer.

11. The display device of claim 1, wherein each of the first phase retardation layer and the second phase retardation layer comprises a λ/4 phase retarder.

12. The display device of claim 1, wherein the display panel further comprises a color filter layer disposed on the light-emitting layer.

13. A display device comprising:
a display panel including a light-emitting layer;
an optical layer disposed on the display panel; and
an optical lens disposed on the optical layer and including a reflective mirror which reflects a portion of light provided from the optical layer,
wherein the optical layer comprises;
a first phase retardation layer disposed on the display panel;
a selective reflection layer disposed on the first phase retardation layer and configured to output linearly polarized light by transmitting light coincident with a polarization axis and to reflect light not coincident with the polarization axis; and
a polarization layer disposed on the selective reflection layer and configured to absorb light reflected by the reflective mirror.

14. The display device of claim 13, wherein the optical layer further comprises a second phase retardation layer in which the linearly polarized light incident from the selective reflection layer is converted into circularly polarized light, wherein the second phase retardation layer is disposed on the selective reflection layer.

15. The display device of claim 14, wherein the optical lens further comprises a phase retardation layer in which the circularly polarized light provided from the reflective mirror is converted into linearly polarized light, wherein the phase retardation layer is disposed on the reflective mirror.

16. The display device of claim 15, wherein the phase retardation layer comprises a N/4 phase retarder, and the optical lens further comprises a wire grid polarization layer disposed on the phase retardation layer.

17. The display device of claim 13, wherein the polarization layer comprises a linear polarizer which linearly polarizes incident light, and absorbs light reflected by the reflective mirror, and the reflective mirror comprises a focus lens which controls a focal length.

18. The display device of claim 13, wherein the selective reflection layer comprises a reflective film layer in which a plurality of layers having respectively different refractive indices are alternately stacked.

19. A display device comprising:
a display panel including a light-emitting layer;
an optical layer disposed on the display panel; and
an optical lens disposed on the optical layer and including an optical lens phase retardation layer in which circularly polarized light provided from the optical layer is converted into linearly polarized light and output by the display device,
wherein the optical layer comprises:
a selective reflection layer disposed on the display panel and configured to output linearly polarized light by transmitting light coincident with a polarization axis and to reflect light not coincident with the polarization axis; and
a second phase retardation layer disposed on the selective reflection layer in which the linearly polarized light incident from the selective reflection layer is converted into the circularly polarized light.

20. The display device of claim 19, wherein the optical layer comprises a polarization layer disposed between the selective reflection layer and the second phase retardation layer, wherein the polarization layer comprises a linear polarizer which linearly polarizes incident light, and absorbs light reflected by the reflective mirror.
